(19) United States
(12) Patent Application Publication
(10) Pub. No.: US 2011/0307855 A1
(43) Pub. Date: Dec. 15, 2011

(54) Software project management apparatuses and methods thereof

(75) Inventors: Enrico Scoda, Martignacco (UD) (IT); Simone Pezzano, Udine (IT)

(73) Assignee: Usablenet Inc., New York, NY (US)

(21) Appl. No.: 12/802,690

(22) Filed: Jun. 11, 2010

(51) Int. Cl. G06F 9/44

(52) U.S. Cl. 717/103

(57) ABSTRACT

A method, computer readable medium and apparatus that manages a software project includes assigning one of one or more virtual hosts in one of one or more workspaces in a development computing device to a remote computing device. The development computing device generates at least one link in the one of the one or more workspaces to at least one of one or more working copies of projects in one of one or more work benches in the one of the one or more virtual hosts. The development computing device generates at least one other link in the one of the one or more workspaces to the linked one of the one or more working copies of projects activated in a running area of the development computing device. The development computing device provides access to the activated one of the one or more working copies of projects to the remote computing device to execute one or more tasks.

### FIELD

This invention relates to software project management apparatuses and methods and, more particularly, to software project management apparatuses that manage projects which involve execution of tasks at remote workbenches, and methods thereof.

### BACKGROUND

Currently, when managing the development of a software project which utilizes an interpreted computer language, such as HTML XML, JavaScript, JSP, and Python, a working copy of the program will be maintained on a production server. A project manager or managers of the software project will assign projects related to the working copy to developers located at remote working computing stations.

The developers at each remote working computing station will obtain a remote copy of the program and then develop and test code for the particular assigned project. Typically, each of these remote working computing stations will include an instance of an interpreter installed for execution and testing of the remote copy. When the remote copy is completed by the developer and needs to be published, the remote copy is transferred from the remote working computing station over to the working copy of the program on the production server. At that point, the developer or the project manager verifies the status of the particular assigned project on the production server.

Unfortunately, when multiple developers are working on different remote copies of the program at the remote working computing stations, there are possible conflicts in concurrency and loss of synchronization among remote copies and working copies. Additionally, each of the remote working computing stations requires a separate instance of the interpreter which can be expensive and also difficult to update and upgrade.

### SUMMARY

A method for managing a software project includes assigning one of one or more virtual hosts in one of one or more workspaces in a development computing device to a remote computing device. The development computing device generates at least one link in the one of the one or more workspaces to at least one of one or more working copies of projects in one of one or more work benches in the one of the one or more virtual hosts. The development computing device generates at least one other link in the one of the one or more workspaces to the linked one of the one or more working copies of projects activated in a running area of the development computing device. The development computing device provides access to the activated one of the one or more working copies of projects to the remote computing device to execute one or more tasks.

A computer readable medium having stored thereon instructions for managing a software project comprising machine executable code which when executed by at least one processor, causes the processor to perform steps including assigning one of one or more virtual hosts in one of one or more workspaces in a development computing device to a remote computing device. At least one link is generated in the one of the one or more workspaces to at least one of one or more working copies of projects in one of one or more work benches in the one of the one or more virtual hosts. At least one other link is generated in the one of the one or more workspaces to the linked one of the one or more working copies of projects activated in a running area of the development computing device. Access is provided to the activated one of the one or more working copies of projects to the remote computing device to execute one or more tasks.

A software development management apparatus has one or more processors and a memory coupled to the one or more processors which are configured to execute programmed instructions stored in the memory including assigning one of one or more virtual hosts in one of one or more workspaces in a development computing device to a remote computing device. At least one link is generated in the one of the one or more workspaces to at least one of one or more working copies of projects in one of one or more work benches in the one of the one or more virtual hosts. At least one other link is generated in the one of the one or more workspaces to the linked one of the one or more working copies of projects activated in a running area of the development computing device. Access is provided to the activated one of the one or more working copies of projects to the remote computing device to execute one or more tasks.

This technology provides a number of advantages including providing a more efficient and effective method for managing projects which involve execution of tasks at remote workbenches. This technology enables multiple software developers to accomplish tasks, such as developing, verifying, and testing, on remote computing workbenches and managers to supervise as if they were all located in one location. As a result, the developers at the remote computing workbenches and managers can be located anywhere. Additionally, this technology allows interpreted computer languages source files to be executed on a development server, eliminating the need to install an instance of the interpreter on each remote computing workbench. This helps to reduce costs and also simplifies updating and upgrading of the interpreter. Further, this technology enables managers to gain an easier and more efficient way to manage and control a software development project through its lifecycle.

### BRIEF DESCRIPTIONS OF THE DRAWINGS

FIG. 1 is a partial block and partial functional diagram of an exemplary system environment with a development server;

FIG. 2 is a functional block diagram of workspaces in the development server shown in FIG. 1;

FIG. 3 is a functional block diagram of one of a workspace and a corresponding workbench in the development server shown in FIG. 1;

FIG. 4 is a flow chart of a method for creating a virtual host in the development server;

FIG. 5 is a flow chart of a method for activating a project in a virtual host in the development server;

FIG. 6 is a flow chart of a method for managing execution of an activation of a project in a virtual host in the development server;

FIG. 7 is a flow chart of a method for editing a project in a user workbench in the development server; and

FIG. 8 is a flow chart of a method for triggering an interpretation of a project in the development server.

### DETAILED DESCRIPTION

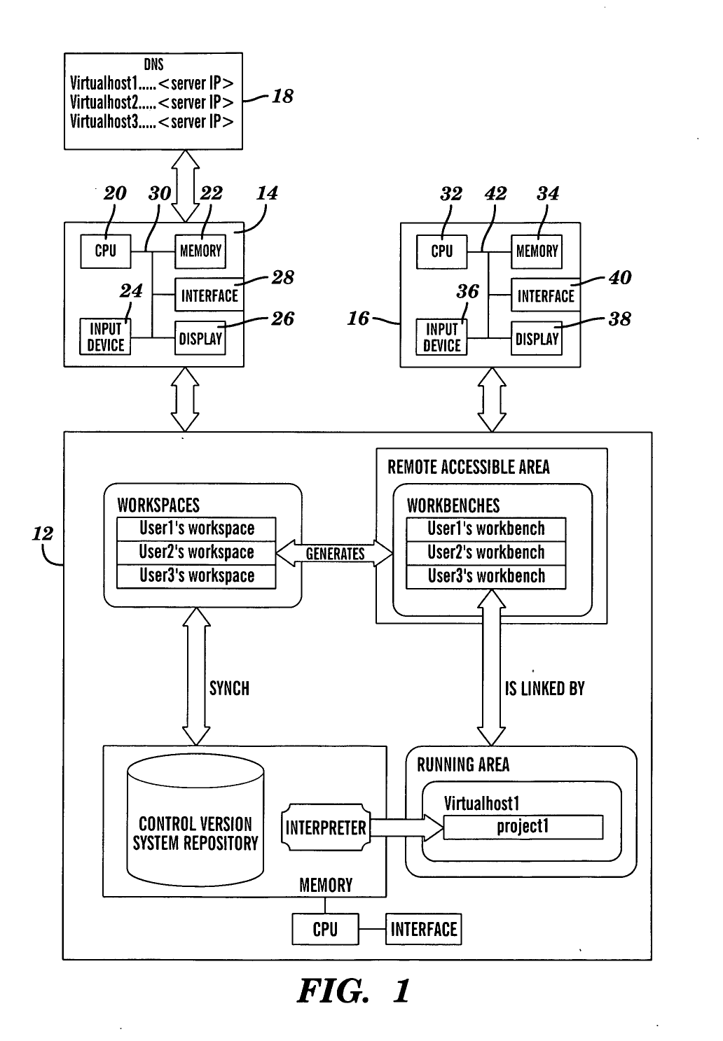

An exemplary environment 10 with a development server 12 is illustrated in FIG. 1. The exemplary environment 10 includes the development server 12, a remote workbench computing device 14, a manager computing device 16, and a domain name server 18 are coupled together by one or more communication networks, although other numbers and types of systems, devices, and/or elements in other configurations and environments with other communication network topologies can be used. This technology provides a number of advantages including providing a more efficient and effective method for managing projects which involve execution of tasks at a remote workbench computing devices.

Referring more specifically to FIG. 1, the development server 12 includes a central processing unit (CPU) or processor, a memory comprising a control version system repository and an interpreter, and an interface system which are coupled together by a bus or other link, although other numbers and types of components, parts, devices, systems, and elements in other configurations and locations can be used as well as other types of computing devices can be used. The processor in the development server 12 executes a program of stored instructions one or more aspects of the present invention as described and illustrated by way of the embodiments herein, although the processor could execute other numbers and types of programmed instructions.

The memory in the development server 12 stores these programmed instructions for one or more aspects of the present invention as described and illustrated herein, including the execution of the methods described herein, although some or all of the programmed instructions as well as other data could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in the development server 12. In this example, the control version system repository and the module with programmed instructions for the interpreter are located in the memory of the development server, although each could be in other locations and have other numbers.

The interface system in the development server 12 is used to operatively couple and communicate between the development server 12 and the remote workbench computing device 14, the manager computing device 16, and the domain name server 18, although other types and numbers of communication networks with other types and numbers of connections and configurations can be used. By way of example only, one or more communication networks can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

The remote workbench computing device 14 in this example is a computing device that includes a central processing unit (CPU) or processor 20, a memory 22, user input device 24, a display 26, and an interface system 28, and which are coupled together by a bus 30 or other link, although one or more of remote workbench computing device 14 can include other numbers and types of components, parts, devices, systems, and elements in other configurations. The processor 20 in the remote workbench computing device 14 executes a program of stored instructions for one or more aspects of the present invention as described and illustrated herein, although the processor could execute other numbers and types of programmed instructions. Although one remote workbench computing device 14 is illustrated in this example, other numbers and types of computing devices could be used.

The memory 22 in the remote workbench computing device 14 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in the remote workbench computing device 14.

The user input device 24 in the remote workbench computing device 14 is used to input selections, although the user input device could be used to input other types of data and interact with other elements. The user input device can include keypads, touch screens, and/or vocal input processing systems although other types and numbers of user input devices can be used.

The display 26 in the remote workbench computing device 14 is used to show data and information to the user. The display in the remote workbench computing device 14 is a computer screen display, although other types and numbers of displays could be used.

The interface system 28 in the remote workbench computing device 14 is used to operatively couple and communicate between the remote workbench computing device 14 and the development server 12, the manager computing device 16, and the domain name server 18 over one or more communication networks, although other types and numbers of communication networks with other types and numbers of connections and configurations can be used.

The manager computing device 16 in this example is a computing device that includes a central processing unit (CPU) or processor 32, a memory 34, user input device 36, a display 38, and an interface system 40, and which are coupled together by a bus 42 or other link, although the manager computing device can include other numbers and types of components, parts, devices, systems, and elements in other configurations. The processor 32 in the manager computing device 16 executes a program of stored instructions for one or more aspects of the present invention as described and illustrated herein, although the processor could execute other numbers and types of programmed instructions. Although one the manager computing device 16 is illustrated in this example, other numbers and types of computing devices could be used

The memory 34 in the manager computing device 16 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 32 can be used for the memory 34 in the manager computing device 16.

The user input device 36 in the manager computing device 16 is used to input selections, although the user input device could be used to input other types of data and interact with other elements. The user input device 36 can include keypads, touch screens, and/or vocal input processing systems although other types and numbers of user input devices can be used.

The display 38 in the manager computing device 16 is used to show data and information to the user. The display in the manager computing device 16 is a computer screen display, although other types and numbers of displays could be used.

The interface system 40 in the manager computing device 16 is used to operatively couple and communicate between the manager computing device 16 and the developmental management server 12, the remote workbench computing device 14, and the domain name server 18 over one or more communication networks, although other types and numbers of communication networks with other types and numbers of connections and configurations can be used.

The domain name server 18 includes a central processing unit (CPU) or processor, a memory, and an interface system which are coupled together by a bus or other link, although other numbers and types of components, parts, devices, systems, and elements in other configurations and locations can be used as well as other types of computing devices can be used. The processor in the domain name server 18 executes a program of stored instructions one or more aspects of the present invention as described and illustrated by way of the embodiments herein including assigning domain name addresses, although the processor could execute other numbers and types of programmed instructions.

The memory in the domain name server 18 stores these programmed instructions for one or more aspects of the present invention as described and illustrated herein, including the execution of the methods described herein, although some or all of the programmed instructions as well as other data could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in the domain name server 18. In this example, the control version system repository and the module with programmed instructions for the interpreter are located in the memory of the development server, although each could be in other locations and have other numbers.

The interface system in the domain name server 18 is used to operatively couple and communicate between the domain name server 18 and the development server 12, the remote workbench computing device 14, and the manager computing device 16, although other types and numbers of communication networks with other types and numbers of connections and configurations can be used.

Although embodiments of the development server 12, the remote workbench computing device 14, manager computing device 16, and domain name server are described and illustrated herein, each can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s). Additionally, other numbers of the development server 12, the remote workbench computing device 14, manager computing device 16, and domain name server 18 could be used.

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

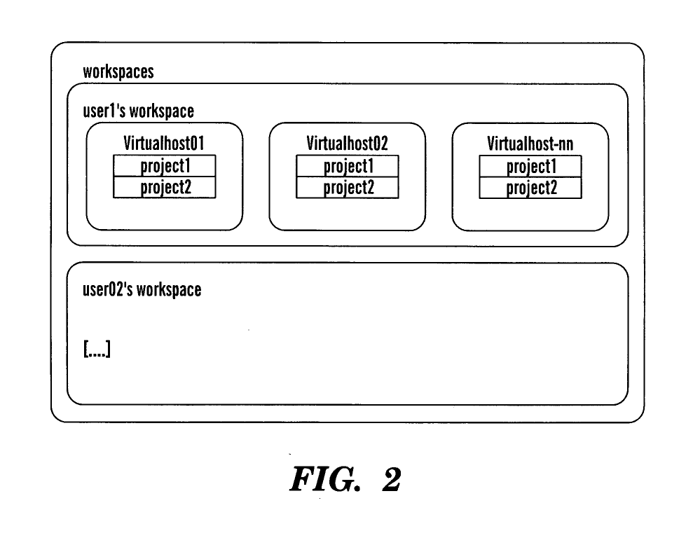

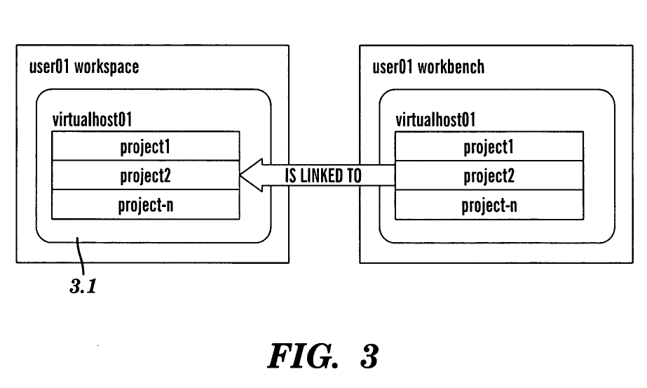

An exemplary method for creating a virtual host in the development server 12 will now be described with reference to FIGS. 1-4. In step 50, a developer, also referred to as user01 or user1 in this example, at the remote workbench computing device 14 submits a request to create a new virtualhost01 for user01 to the development server 12. In step 52, the development server 12 processes the received request and determines which one of one or more control version system repository is appropriate for one or more projects assigned to the developer (user01 in this example) at the remote workstation computing device 14. In step 54, the development server 12 fetches the one of the control version system repositories determined to be appropriate for the one or more projects assigned to the developer (user01 in this example). In step 56, the development server 12 creates the new virtualhost01 in the workspace for user01 at the remote workstation computing device 14 to remotely access as illustrated in FIGS. 2-3. In step 58, the development server 12 creates the new virtualhost01 in the workbench for the developer (user01 in this example) which is at the development server 12 as illustrated in FIG. 3. In step 60, the developement server 12 runs a checkout so that the content for the one or more projects assigned to the developer (user01 in this example) are downloaded in the newly created virtualhost01 in the workspace for the developer (user01 in this example) at the remote workstation computing device 14 to acess via the interne connection in this example.

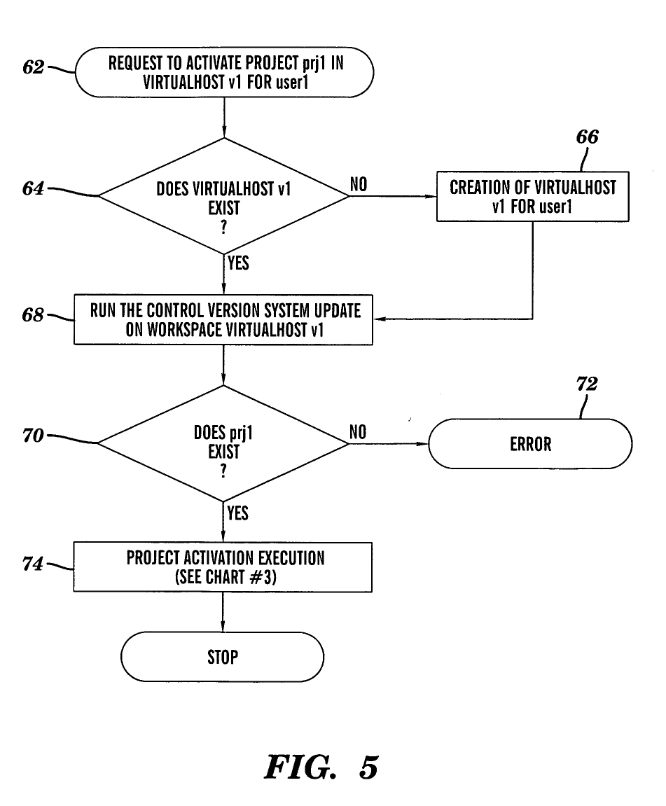

An exemplary method for activating a project in a virtual host in the development server will now be described with reference to FIGS. 1-3 and 5. In step 62, a manager at the manager computing device 16 requests to active project1 in the virtualhost01 for the developer (user01 in this example) in the development server 12 for user01 at the remote workbench computing device 14.

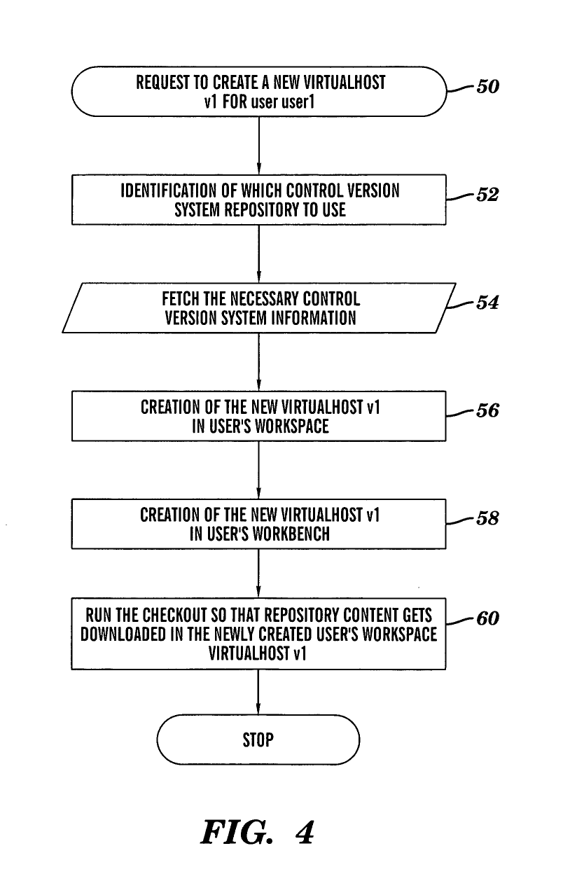

In step 64, the development server 12 determines whether the virtualhost01 for the developer (user01 in this example) exists. If in step 64 the development server 12 determines the virtualhost01 for the developer (user01 in this example) does not exist, then the No branch is taken to step 66. In step 66, the development server 12 creates the virtualhost01 for user01 using the method described with reference to FIG. 4. If in step 64 the development server 12 determines the virtualhost01 for the developer (user01 in this example) does exist, then the Yes branch is taken to step 68. In step 68, the development server 12 runs a control version system update for one or more of the projects assigned to the virtualhost01 on the workspace for the developer (user01 in this example).

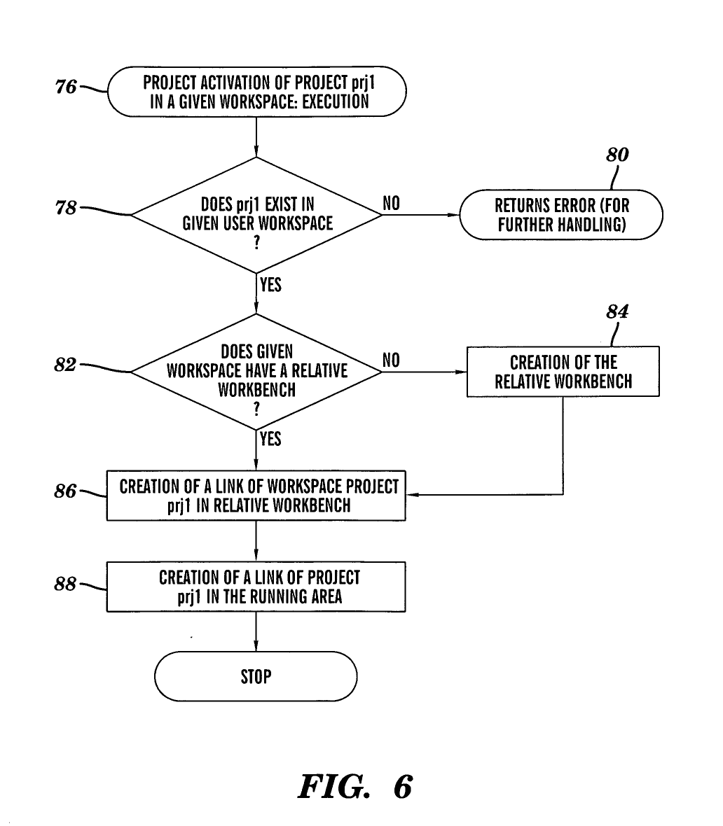

In step 70, the development server 12 determines whether the project1 the manager at the manager computing device 16 has requested to active exists in the virtualhost01 on the workspace for the developer (user01 in this example), although one or more of the projects can be activated in other manners and from other sources. If in step 70 the development server 12 determines the project1 the manager at the manager computing device 16 has requested to active does not exist in the virtualhost01 on the workspace for the developer (user01 in this example), then the No branch is taken to step 72 resulting in an error message, although other manners for indicating an error can be used. If in step 70 the development server 12 determines the project1 the manager at the manager computing device 16 has requested to active does exist in the virtualhost01 on the workspace for the developer (user01 in this example), then the Yes branch is taken to step 74 where the execution of the activation of a project1 is carried out as explained in greater detail with reference to FIG. 6.

An exemplary method for managing execution of an activation of a project in a virtual host in the development server 12 will now be described with reference to FIGS. 1-3 and 6. In step 76, the development server 12 begins the execution of the activation of a project1 in the virtualhost01 in the development server 12. The developer at the remote workstation computing device 14 accesses the activated project1 in the virtualhost01 in the development server 12 remotely via an internet connection, although other manners for accessing the project can be used.

In step 78 the development server 12 determines whether the project1 exists in the workspace for user01 for the developer at the remote workstation computing device 14 to execute one or more tasks. If in step 78 the development server 12 determines the project1 does not exist in the workspace for the developer (user01 in this example), then the No branch is taken to step 80 resulting in an error message sent to the remote workstation computing device 14, although other manners for indicating an error can be used. If in step 78 the development server 12 determines the project1 does exist in the workspace for the developer (user01 in this example), then the Yes branch is taken to step 82.

In step 82 the development server 12 determines whether the workspace for the developer (user01 in this example) has an associated workbench for user01 in the virtualhost01. If in step 82 the development server 12 determines the workspace for user01 does not have an associated workbench for the developer (user01 in this example), then the No branch is taken to step 84. In step 84, the development server 12 creates a workbench for the developer (user01 in this example) associated with the workspace for user01 in the virtualhost01. If in step 82 the development server 12 determines the workspace for the developer (user01 in this example) does have an associated workspace for user01, then the Yes branch is taken to step 86. In step 86, the development server 12 creates a link between the project1 in the workspace for the developer (user01 in this example) and the project1 in the workbench for the developer (user01 in this example) as shown in FIG. 3. In step 88, the development server 12 creates a link from the project1 in workbench for user01 to a running area in the development server 12 as illustrated in FIG. 1.

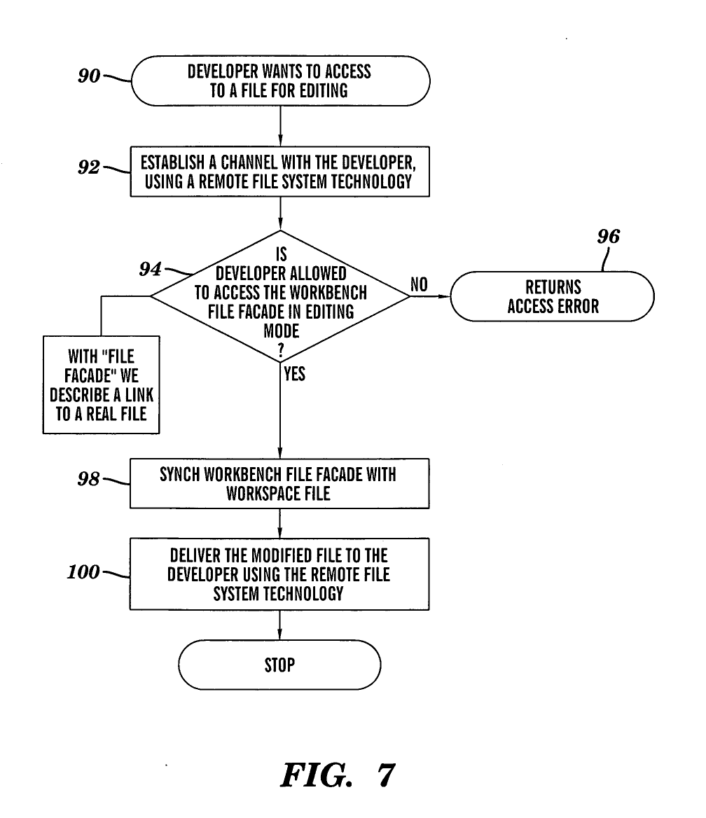

An exemplary method for editing a project in a user workbench in the development server 12 will now be described with reference to FIGS. 1-3 and 7. In step 90, a developer at the remote workstation computing device 12 begins this method for accessing a project, such as a computer file by way of example, for editing or other tasks. In step 92, the remote workstation computing device 12 establishes a secure channel with the development system 12 using a remote file system technology, although other manners for establishing a secure or unsecure connection could be used. The domain name server 18 is used to assign an IP addresses to the virtualhost in the development server 12 which is used by the remote workstation computing device 14 to access and interact with one or more activated projects, although other manners for connecting and communicating between the devices can be used.

In step 94 the development server 12 determines whether the developer (user01) at the remote workstation computing device 12 is permitted to access the workbench for user01. If in step 94 the development server 12 determines the developer (user01) at the remote workstation computing device 12 is not permitted to access the workbench for developer (user01), then the No branch is taken to step 96 which returns an error message. If in step 94 the development server 12 determines the developer (user01) at the remote workstation computing device 12 is permitted to access the workbench for developer (user01), then the Yes branch is taken to step 98.

In step 98, the development system 12 synchronizes the links to the one or more projects in the workbench for user01 to the one or more real files for the projects located in the workbench for user01. In step 100, the development system 12 provides access to the synchronized projects to developer (user01) at the remote workstation computing device 12 through the virtualhost, although other manners for providing access can be used.

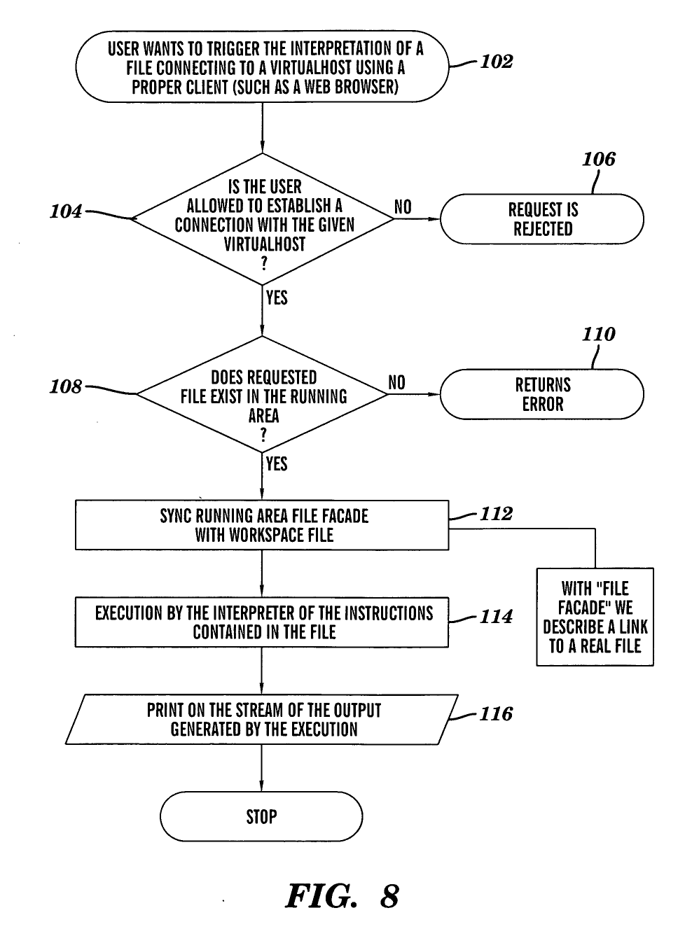

An exemplary method for triggering an interpretation of a project in the development server 12 will now be described with reference to FIGS. 1-3 and 8. In step 102, a developer (user01) at the remote workstation computing device 12 begins this method for triggering an interpretation of a project in the development server 12.

In step 104 the development server 12 determines whether the developer (user01) requesting an interpretation of the project1 is allowed to establish a connection with the virtualhost1, although other devices and manners for requesting an interpretatin can be used, such as a request from a manager at the manager computng device 16. If in step 104 the development server 12 determines the developer (user01) requesting an interpretation of the project1 is not allowed to establish a connection with the virtualhost1, then the No branch is taken to step 106 where the request is rejected. If in step 104 the development server 12 determines the developer (user01) requesting an interpretation of the project1 is allowed to establish a connection with the virtualhost1, then the Yes branch is taken to step 108.

In step 108 the development server 12 determines whether the requested project1 or other file exists in the running area for interpretation. If in step 108 the development server 12 determines the requested project1 does not exist in the running area for interpretation, then the No branch is taken to step 110 where an error message is returned. If in step 108 the development server 12 determines the requested project1 does exist in the running area for interpretation, then the Yes branch is taken to step 112.

In step 112, the development server 12 synchronizes the project1 in the running area with the project1 in the workspace for user01. In step 114, the development server 12 executes the interpreter to interpret the instructions in project1 or other file being interpreted. In step 116 the development server prints the output generated by the interpretation, although the output could be handled or stored in other manners.

Accordingly as illustrated and described herein, this technology provides a remote workbench and a remote virtual host. The remote workbench provides a working area in the development server 12 that can be accessed remotely by software developers at a remote workstation computing device and lets them work on tasks on the project as if they were located locally. The remote virtual host is a virtual host that is assigned to the developer through which the developer can launch and execute tasks on any project that is in its workbench. The development server 12 in the examples described herein is TCP/IP accessible, executes the programmed instructions for one or more aspects of the invention and is where the interpreter is installed. Additionally, with this technology, a project manager at a manager computing device 16 can verify with the development server 12 the status of any project at any moment. Even though working remotely, the developers at each remote workbench computing device never face concurrency because every developer owns a working copy in the development server 12.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing a software project, the method comprising:
assigning one of one or more virtual hosts in one of one or more workspaces in a development computing device to a remote computing device;
generating with the development computing device at least one link in the one of the one or more workspaces to at least one of one or more working copies of projects in one of one or more work benches in the one of the one or more virtual hosts;
generating with the development computing device at least one other link in the one of the one or more workspaces to the linked one of the one or more working copies of projects activated in a running area of the development computing device; and
providing with the development computing device access to the activated one of the one or more working copies of projects to the remote computing device to execute one or more tasks.

2. The method as set forth in claim 1 further comprising:
linking with the development computing device the activated one of the one or more working copies of projects to one of one or more control version repositories; and
replicating with the development computing device and the one of one or more control version repositories each of the executed one or more tasks on the activated one of the one or more working copies of projects on the other one or more workspaces.

3. The method as set forth in claim 2 further comprising identifying with the development computing device which one of the one of one or more control version repositories to link with the activated one of the one or more working copies of projects.

4. The method as set forth in claim 1 further comprising:
receiving a request at the development computing device to interpret the activated one of the one or more working copies of projects; and
interpreting with an interpreter in the development computing device the activated one of the one or more working copies of projects.

5. The method as set forth in claim 4 further comprising at least one of updating and upgrading the interpreter in the development computing device.

6. The method as set forth in claim 1 further comprising:
receiving at the development computing device an activation request for one of the one or more working copies of projects; and
activating with the development computing device the requested one of the one or more working copies of projects to create the activated one of the one or more working copies of projects.

7. The method as set forth in claim 1 further comprising creating with the development computing device the one or more virtual hosts.

8. The method as set forth in claim 7 further comprising associating a domain name for each of the one or more virtual hosts to an IP address for the development computing device.

9. A computer readable medium having stored thereon instructions for managing a software project comprising machine executable code which when executed by at least one processor, causes the processor to perform steps:
assigning one of one or more virtual hosts in one of one or more workspaces in a development computing device to a remote computing device;
generating at least one link in the one of the one or more workspaces to at least one of one or more working copies of projects in one of one or more work benches in the one of the one or more virtual hosts;
generating at least one other link in the one of the one or more workspaces to the linked one of the one or more working copies of projects activated in a running area of the development computing device; and
providing access to the activated one of the one or more working copies of projects to the remote computing device to execute one or more tasks.

10. The medium as set forth in claim 9 further comprising:
linking the activated one of the one or more working copies of projects to one of one or more control version repositories; and
replicating each of the executed one or more tasks on the activated one of the one or more working copies of projects on the other one or more workspaces.

11. The medium as set forth in claim 10 further comprising identifying which one of the one of one or more control version repositories to link with the activated one of the one or more working copies of projects.

12. The medium as set forth in claim 9 further comprising:
receiving a request to interpret the activated one of the one or more working copies of projects; and
interpreting with an interpreter the activated one Of the one or more working copies of projects.

13. The medium as set forth in claim 12 further comprising at least one of updating and upgrading the interpreter.

14. The medium as set forth in claim 9 further comprising:
receiving an activation request for one of the one or more working copies of projects; and
activating the requested one of the one or more working copies of projects to create the activated one of the one or more working copies of projects.

15. The medium as set forth in claim 9 further comprising creating the one or more virtual hosts.

16. The medium as set forth in claim 15 further comprising associating a domain name for each of the one or more virtual hosts to an IP address for the development computing device.

17. A software development management apparatus comprising:
one or more processors;
a memory coupled to the one or more processors which are configured to execute programmed instructions stored in the memory comprising:
assigning one of one or more virtual hosts in one of one or more workspaces in a development computing device to a remote computing device;
generating at least one link in the one of the one or more workspaces to at least one of one or more working copies of projects in one of one or more work benches in the one of the one or more virtual hosts;
generating at least one other link in the one of the one or more workspaces to the linked one of the one or more working copies of projects activated in a running area of the development computing device; and
providing access to the activated one of the one or more working copies of projects to the remote computing device to execute one or more tasks.

18. The apparatus as set-forth in claim 17 wherein the one or more processors is further configured to execute programmed instructions stored in the memory further comprising:
linking the activated one of the one or more working copies of projects to one of one or more control version repositories; and
replicating each of the executed one or more tasks on the activated one of the one or more working copies of projects on the other one or more workspaces.

19. The apparatus as set forth in claim 18 wherein the one or more processors is further configured to execute programmed instructions stored in the memory further comprising identifying which one of the one of one or more control version repositories to link with the activated one of the one or more working copies of projects.

20. The apparatus as set forth in claim 17 wherein the one or more processors is further configured to execute programmed instructions stored in the memory further comprising:
receiving a request to interpret the activated one of the one or more working copies of projects; and
interpreting with an interpreter the activated one of the one or more working copies of projects.

21. The apparatus as set forth in claim 20 wherein the one or more processors is further configured to execute programmed instructions stored in the memory further comprising at least one of updating and upgrading the interpreter.

22. The apparatus as set forth in claim 17 wherein the one or more processors is further configured to execute programmed instructions stored in the memory further comprising:
receiving an activation request for one of the one or more working copies of projects; and
activating the requested one of the one or more working copies of projects to create the activated one of the one or more working copies of projects.

23. The apparatus as set forth in claim 17 wherein the one or more processors is further configured to execute programmed instructions stored in the memory further comprising creating the one or more virtual hosts.

24. The apparatus as set forth in claim 23 wherein the one or more processors is further configured to execute programmed instructions stored in the memory further comprising associating a domain name for each of the one or more virtual hosts to an IP address for the development computing device.
